(19) United States
(12) Patent Application Publication
(10) Pub. No.: US 2019/0289859 A1
(43) Pub. Date: Sep. 26, 2019

(54) Baking Machine and Winding Device

(71) Applicant: HAAS FOOD EQUIPMENT GMBH, Wien (AT)

(72) Inventors: Stefan Jiraschek, Königsbrunn (AT); Ralf Dolezel, Wien (AT); Markus Bibaric, Kierling (AT); Michael Steinböck, Holzleiten (AT)

(73) Assignee: HAAS FOOD EQUIPMENT GMBH, Wien (AT)

(21) Appl. No.: 16/318,705

(22) PCT Filed: Jul. 17, 2017
(86) PCT No.: PCT/EP2017/067996

§ 371 Date: Jan. 17, 2019

(30) Foreign Application Priority Data
Jul. 20, 2016 (EP) 16180298.8

(51) Int. Cl. A21C 15/02; A21B 5/02

(52) U.S. Cl. CPC A21C 15/025; A21C 15/007; A21B 5/026

(57) ABSTRACT

A baking machine includes a winding device (1) for the continuous production of edible wafer rolls provided on the inside with an edible substance. The winding device has a mandrel (2) with a cylindrical winding wall (6) having an exterior winding surface (7) which is adapted for abutment and for rolling of a warm plastically deformable wafer strip and by dint of which, during operation, heat transfer takes place due to the abutment of the wafer strip. An interior of the cylindrical winding wall (6) defines a substance channel (8) for introducing the edible substance into an interior of the wafer roll, and at least one temperature-control channel (9) for guiding a temperature-control medium therethrough. The temperature-control channel (9) extends from a mounted portion (3) of the mandrel (2) into a projecting portion (4) of the mandrel (2) and back again into the mounted portion (3) of the mandrel (2).

### CROSS-REFERENCE TO RELATED APPLICATION(S)

This application is the National Stage of International Patent Application No. PCT/EP2017/067996 filed on Jul. 17, 2017, which claims priority from European Patent Application No. 16180298.8 filed on Jul. 20, 2016, both of which are herein incorporated by reference herein in their entireties.

### BACKGROUND

### 1. Field

The invention relates to a winding device and a baking machine.

### 2. State of the Art

Baking machines, in particular ring baking machines for the continuous production of wafer rolls have been known and public for some time.

The invention relates in particular to a baking machine such as is described, for example, in the publications AT 381 440 B, AT 514 571 B1, EP 1 175 150 B1, AT 409 703 B, AT 413 177 B, wherein a new type of winding device is used.

Conventional ring baking machines comprise a cylindrical baking surface which is turned continuously about its axis of rotation, on which wafer strips which are plastically deformable in the warm state are baked, which wafer strips are then removed from the cylindrical baking surface by means of a removing and winding device and rolled up. The rolling up or winding of the wafer strip takes place in a continuous advancing movement of the roll to be formed between a rotatably driven mandrel and a pressing roller of the winding device. As a result, a substantially endless wafer roll is formed, which is cut to length at predefined intervals to form wafer rolls.

According to the prior art, winding devices are also known by means of which a cream can be inserted into the interior of the wafer roll during winding of the wafer strip. Depending on the case of application, it can be necessary for this purpose that the cream to be introduced into the wafer roll does not fall below or exceed a certain temperature value, with the result that a temperature control of the substance channel and/or of the mandrel of the winding device is necessary. The reason for this is that the mandrel has an external winding surface which abuts directly against the hot wafer strip. It is unavoidable that heat is transferred from the hot wafer strip onto this winding surface.

For example, pipe-in-pipe systems are known for cooling the mandrel, in which a thin substance channel is located centrally in the interior of the hollow mandrel, wherein the substance channel is flushed by a coolant such as, for example, water. A disadvantage with this structure is that the thin channel provided in the mandrel is on the one hand not suitable for conveying a sufficient substance volume flow. Furthermore, in thin channels there is the risk that they become clogged by a viscous substance.

In the case of a central arrangement of a substance channel having larger diameter, it can hitherto not be avoided for production technology reasons that the substance channel abuts against the exterior wall of the mandrel at least in sections.

### SUMMARY

It is now the object of the invention to provide a winding device and a baking machine, in particular a ring baking machine which overcomes the disadvantages of the prior art. This in particular comprises the fact that the winding device is also suitable for introducing temperature-sensitive substances into the wafer rolls in sufficient quality and quantity.

The object according to the invention is solved in particular by the hereinafter described features.

The invention relates in particular to a winding device for the continuous production of edible wafer rolls provided on the inside with a substance such as, for example, an edible cream, wherein the winding device comprises a mandrel running along a main axis, wherein the mandrel comprises a mounted portion and a projecting portion having a free end, wherein the mandrel in its projecting portion is delimited transversely to the main axis by a cylindrical winding wall, wherein the cylindrical winding wall has an exterior winding surface, which is adapted for abutment and for rolling of a warm plastically deformable wafer strip and by means of which during operation in particular heat transfer takes place due to the abutment of the wafer strip, wherein in the interior of the cylindrical winding wall a substance channel running along the main axis is provided for introducing a substance into the interior of an endless sleeve-shaped hollow body or of the wafer rolls, wherein the substance channel exits from the mandrel in the region of the free end, wherein the substance channel is delimited by a substance channel wall, and/or wherein at least one temperature-control channel for guiding a temperature-control medium, in particular a temperature-control fluid, is provided in the interior of the cylindrical winding wall.

Optionally it is provided that the temperature-control channel extends from the mounted portion of the mandrel into the projecting portion of the mandrel and back again into the mounted portion of the mandrel.

Optionally it is provided that the temperature-control channel runs between the substance channel and the winding wall.

Optionally it is provided that the temperature-control channel is configured to be substantially U-shaped and extends in particular as a closed line from the mounted portion of the mandrel into the projecting portion of the mandrel and back again into the mounted portion of the mandrel.

Optionally it is provided that the temperature-control channel comprises a first portion which extends in the interior of the winding wall along the main axis from the mounted portion of the mandrel into the projecting portion of the mandrel

Optionally it is provided that the temperature-control channel comprises a second portion downstream of the first portion which extends in the interior of the winding wall along the main axis from the projecting portion of the mandrel back again into the mounted portion of the mandrel.

Optionally it is provided that the temperature-control channel is at least partially delimited or formed by the substance channel wall and by the winding wall.

Optionally it is provided that the winding wall has a circular or round cross-section, that the substance channel in the interior of the winding wall has an elongate cross-section and/or that the temperature-control channel is arranged in the free cross-section between the substance channel wall of the substance channel and the winding wall.

Optionally it is provided that the winding wall has a round or circular cross-section, that the substance channel and/or the substance channel wall has an elongate cross-section in the region of the winding wall, wherein the elongate cross-section extends along a first cross-section axis from the one side of the winding wall to the opposite side of the winding wall, and wherein a free cross-section in which the temperature-control channel is arranged is provided between the elongate cross-section of the substance channel wall and the winding wall along a second cross-section axis running normally to the first cross-section axis in the cross-section plane.

Optionally it is provided that the winding wall has a round or circular cross-section, that the substance channel and/or the substance channel wall has an elongate cross-section in the region of the winding wall, wherein the elongate cross-section extends along a first cross-section axis from the one side of the winding wall to the opposite side of the winding wall, and wherein a free cross-section in which the first portion and the second portion of the temperature-control channel are arranged adjacently following the main axis is provided between the elongate cross-section of the substance channel wall and the winding wall along a second cross-section axis running normally to the first cross-section axis in the cross-section plane.

Optionally it is provided that in the interior of the cylindrical winding wall two temperature-control channels are provided for conducting a temperature-control medium which are both configured according to the preceding and following description.

Optionally it is provided that in the interior of the cylindrical winding wall two temperature-control channels are provided for conducting a temperature-control medium which are both configured according to one of the preceding claims, that the substance channel in the interior of the winding wall has an elongate cross-section, and/or that the two temperature-control channels are arranged on both sides of the substance channel in the free cross-sections between the substance channel wall of the substance channel and the winding wall.

Optionally it is provided that the mandrel is arranged rotatably or rotatably driven about the main axis, that the mandrel is surrounded in the region of its mounted portion by an annular feed chamber for supplying the temperature-control medium into the temperature-control channel of the rotating mandrel and that the mandrel in the region of its mounted portion is spaced apart from the annular feed chamber by an annular discharge chamber for discharging the temperature-control medium from the temperature-control channel of the rotating mandrel.

Optionally it is provided that the temperature-control channel comprises a first portion which extends in the interior of the winding wall along the main axis from the mounted portion of the mandrel into the projecting portion of the mandrel, that the temperature-control channel comprises a second portion downstream of the first portion which extends in the interior of the winding wall along the main axis from the projecting portion of the mandrel back again into the mounted portion of the mandrel, that the first portion extends as far as into the mounted portion of the mandrel and there opens in the radial direction or obliquely into the annular feed chamber and/or that the second portion extends as far as into the mounted portion of the mandrel and there opens in the radial direction into the annular discharge chamber.

Optionally it is provided that a pressing roller which is rotatable or driven rotatably about an auxiliary axis is provided.

Optionally the invention relates to a baking machine for the continuous production of edible wafer rolls comprising at least one continuously circulating heated baking surface for baking at least one endless wafer strip which is plastically deformable in the warm state and which is made of a liquid sugar-containing wafer dough and comprising a processing station in which for each baked wafer strip there is provided a removing device adjacent to the baking surface, a winding device downstream of this removing device for producing an endless sleeve-shaped hollow body and a cutting device downstream of the winding device for cutting to length the sleeve-shaped hollow body into individual wafer rolls.

Optionally it is provided that the or each winding device has a winding gap arranged obliquely to the path of the relevant baked wafer strip which is formed between two oppositely rotating winding units of which one winding unit is configured as mandrel around which the baked wafer strip is wound in a helical overlapping manner to form an endless sleeve-shaped hollow body and the other winding unit is configured as a pressing roller which presses the baked wafer strip against the rotating mandrel.

In all the embodiments, the sleeve-shaped hollow body is preferably configured as a rolled or wound wafer roll.

Optionally it is provided that that the winding wall has a circular or round cross-section, that the substance channel in the interior of the winding wall has a round cross-section arranged concentrically to the winding wall and/or that the temperature-control channel is arranged in the free, in particular annularly shaped cross-section between the substance channel wall of the substance channel and the winding wall.

Optionally it is provided that the temperature-control channel runs at least in sections spirally or helically between the substance channel wall of the substance channel and the winding wall.

The winding device according to the invention comprises a mandrel which is temperature-controlled, preferably cooled or optionally heated by means of a specially formed temperature-control channel. In all the embodiments it can be provided that several temperature-control channels are provided in a mandrel. These temperature-control channels can be of the same type and provided in particular symmetrically in or on the mandrel.

The temperature-control medium, for example a temperature-control fluid such as water, preferably has a lower viscosity than the substance to be introduced into the wafer rolls. As a result, the temperature-control channel for conducting the temperature-control medium can be configured to be tighter or narrower at least in some regions than the substance channel for supplying the substance. The substance channel is preferably configured in such a manner that its cross-section is configured to be rounded and in particular comprises no narrow, tight or pointed regions. Optionally the temperature-control medium can also be gaseous or in particular air or compressed air.

Preferably in all embodiments the temperature-control medium can be conveyed through the temperature-control channel for cooling the mandrel or the substance located in the mandrel. Optionally in all embodiments the temperature-control medium can be conveyed through the temperature-control channel for heating the mandrel or the substance located in the mandrel.

Preferably the mandrel comprises a mounted portion and a projecting portion, wherein the mounted portion in particular is a portion of the mandrel in which it is surrounded or embraced by another element of the device such as, for example, by a ball bearing, a plain bearing or by an annular chamber for the supply and discharge of the temperature-control medium. The projecting portion is in particular that portion of the mandrel in which the winding surface is provided.

The wafer rolls to be produced are preferably provided on their inside with a substance such as for example with an edible cream, in particular a chocolate cream or a fatty cream. The wafer rolls can be provided with a coating, which completely or partially lines the inner side of the wafer rolls. Optionally the wafer rolls are partially or completely filled with a substance.

The mandrel preferably comprises a projecting portion and a mounted portion and projects from the mounted portion so that a free end is formed. On the projecting portion of the mandrel, a cylindrical winding wall is provided at least in sections which bears a winding surface on the outer side thereof. During operation the hot or warm deformable wafer strip abuts against this winding surface to form the wafer rolls.

In order to enable a temperature control of the mandrel, at least one temperature-control channel is provided which is adapted for conducting a temperature-control medium. Preferably two or more temperature-control channels are provided to enable an improved temperature control or temperature-control performance. Furthermore a substance channel for supplying a substance is provided in the mandrel, wherein the substance channel emerges from the mandrel, in particular in the region of the free end.

The temperature-control channel or channels on the other hand are configured to be substantially closed and extend from the mounted portion into a projecting portion and back again into the mounted portion. Any escape of the temperature-control medium onto or into the wafer roll to be formed is prevented by the closed formation of the temperature-control channel. The temperature-control is however preferably open in the mounted portion or guided from the mandrel. In particular, the temperature-control channel extends in the radial direction or obliquely from the mandrel into an annular chamber surrounding this region. The annular chamber enables a continuous supply of the temperature-control medium into the rotating mandrel.

The temperature-control channel is configured to be substantially U-shaped. This means in particular that it extends, as described further above, from the mounted portion into the projecting portion and turned in a U-shape back from the projecting portion into the mounted portion. To this end, the temperature-control portion comprises a first portion and a second portion. The first portion extends from the mounted portion into the projecting portion. After the turning point or in particular during the return of the temperature-control medium, said medium flows back through the second portion which extends from the projecting portion of the mandrel back into the mounted portion of the mandrel. The first portion is in this case arranged upstream of the second portion in terms of the flow.

The temperature-control channel is preferably delimited at least partially by the substance channel wall, in particular by the outer side of the substance channel wall. Preferably the temperature-control channel is also delimited at least in sections or partially by the winding wall, in particular by the inner side of the winding wall.

The winding wall preferably has a circular cross-section. This circular cross-section is formed in particular by a cylindrical configuration of the winding wall, the rotation body axis of which is preferably the main axis about which the mandrel is also rotated during rotation. According to a preferred embodiment however, the substance channel has an elongate cross-section which is enclosed in the round cross-section of the winding wall. In particular, the elongate cross-section of the substance channel wall has a smaller extension along a second cross-section axis than the inner side of the winding wall, with the result that a free cross-section is kept free between the winding wall and the substance channel. In particular, the temperature-control channel or the temperature-control channels runs or run in this free cross-section. Optionally the substance channel extends along a first cross-section axis which runs substantially normal to the substance channel, from one side of the winding wall to the opposite side of the winding wall.

Preferably two free cross-sections are kept free due to the different configuration of the winding wall and the substance channel wall so that two temperature-control channels can be provided. The first portion of each temperature-control channel and the second portion of each temperature-control channel preferably run adjacent to one another each in one cross-section which is kept free. The elongate cross-section of the substance channel is preferably configured to be oval or elliptical. Optionally the elongate channel can however also be configured to be polygonal. Preferably the elongate cross-section of the substance channel has an extension from one side of the winding wall to the other side of the winding wall.

Optionally no temperature-control channel is provided in the region of the free end of the mandrel. In particular, the projecting end can be offset in the form of a shoulder and have an at least slightly smaller diameter than the winding wall. According to a preferred embodiment, the temperature-control channel thus ends at a distance from the free end of the mandrel. In this region the wafer strip can, for example, already be cooled to such an extent that no additional cooling is required.

Preferably the winding device comprises a pressing roller which is rotatable or driven rotatably about an auxiliary axis. This pressing roller comprises in particular helical recesses or elevations which are configured to promote an advancing movement of the rolled wafer strip along the direction of the main axis.

The invention preferably also relates to a baking machine for the continuous production of edible wafer rolls which comprises a winding device according to the invention.

The invention in particular also relates to a baking machine for producing endless strips of preferably liquid baking substances on a baking surface support which circulates in a machine frame and which is heated at least in sections, which transports at least one endless baking surface through at least one baking zone extending from a baking substance application device containing a heating device, which is arranged in a stationary manner in the machine frame to a strip removing device, wherein preferably a rotatably mounted and driven hubless drum is provided as a circulating heating baking surface support and wherein a winding device is provided for the continuous formation of a wafer roll.

The invention also relates in particular to a device for producing a hollow baked produced for receiving a soft filling substance, for example, an ice cream, a sugar-containing fatty cream and/or a chocolate cream. The hollow baked product, in particular the wafer roll is preferably formed from a baked product strip wound in a helical and overlapping manner.

### BRIEF DESCRIPTION OF THE DRAWINGS

The invention is described subsequently in further detail with reference to the figures, wherein

FIG. 1 shows a plan view of a baking machine according to the invention,

FIG. 2 shows a schematic oblique view of the winding device,

FIG. 3 shows a schematic sectional view of the winding device,

FIG. 4 shows a cross-section of the mandrel in the area of the winding wall and FIGS. 5 and 6 show two different sections of the mandrel.

### DETAILED DESCRIPTION OF THE DRAWINGS

Unless specified differently, the reference numbers correspond to the following components: winding device 1, mandrel 2, mounted portion (of the mandrel 3), projecting portion (of the mandrel) 4, main axis 5, winding wall 6, winding surface 7, substance channel 8, temperature-control channel 9, substance channel wall 10, first portion (of the temperature-control channel) 11, second portion (of the temperature-control channel) 12, free cross-section 13, first cross-section axis 14, second cross-section axis 15, annular feed chamber 16, annular discharge chamber 17, pressing roller 18, free end (of the mandrel) 19, temperature-control channel wall 20, heated baking surface 21, endless wafer strips 22, processing station 23, removing device 24, cutting device 25, and baking machine 26.

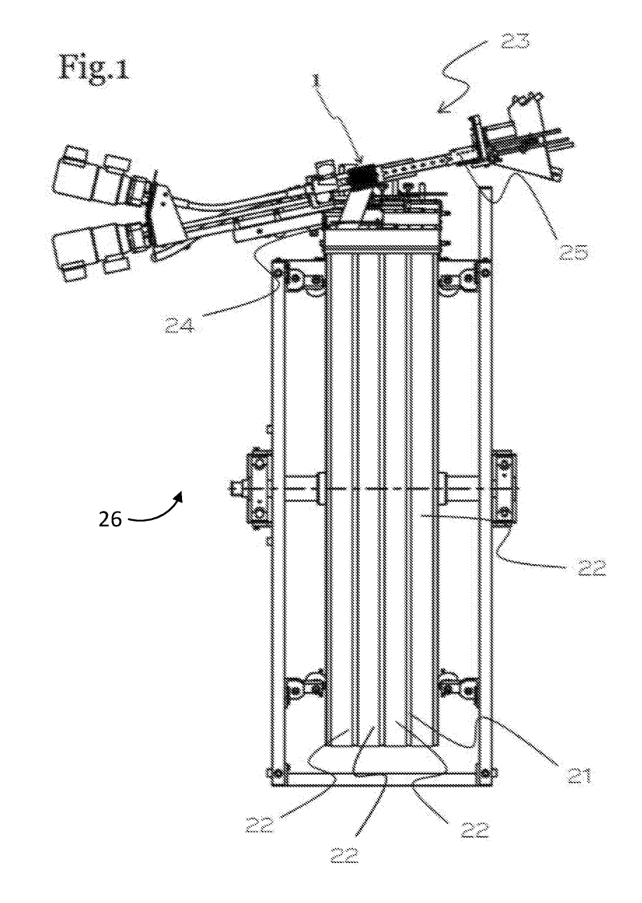

FIG. 1 shows a schematic plan view of a baking machine 26 comprising a winding device 1 according to the invention. In particular, a plurality of winding devices 1 can be provided for the processing of several wafer strips 22. The baking machine 26 for the continuous production of edible wafer rolls can be configured according to the prior art apart from the winding device 1 according to the invention so as to include at least one continuously circulating heated baking surface 21 for baking at least one endless wafer strip 22 which is plastically deformable in the warm state and which is made of a liquid sugar-containing wafer dough, a processing station 23 in which for each baked wafer strip 22 there is provided a removing device 24 adjacent to the baking surface 21 where the removing device 24 is located upstream of the winding device that produces an endless sleeve-shaped hollow body, and a cutting device 25 located downstream of the winding device for cutting to length the sleeve-shaped hollow body into individual wafer rolls. In particular, the feeding of the substance into the winding device can also be accomplished according to conventional devices. Optionally, the winding device of a conventional baking machine, in particular a conventional ring baking machine, can be replaced by the newly proposed winding device.

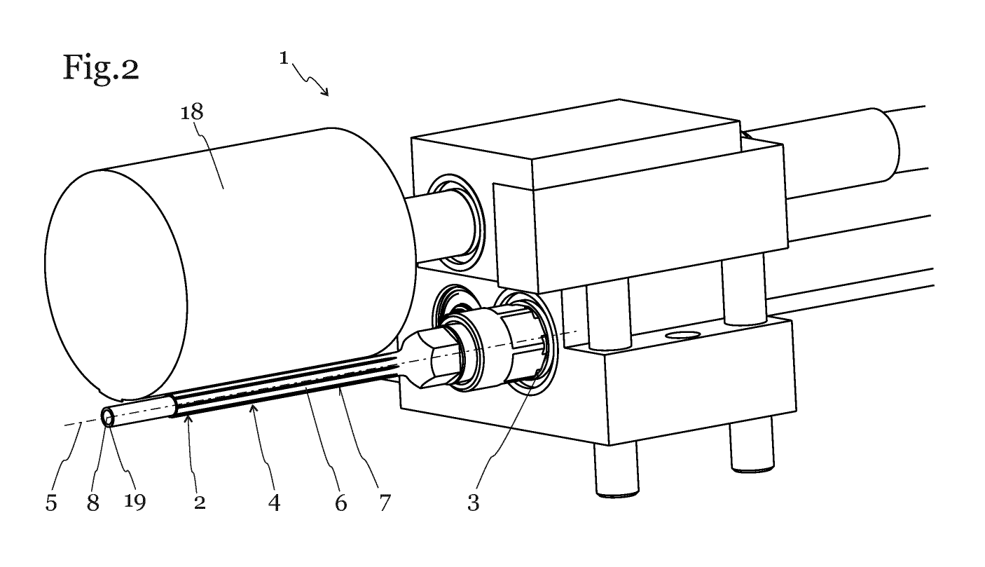

FIG. 2 shows a winding device 1 in a schematic oblique view. In particular, this winding device 1 can be attached to conventional ring baking machines in order to enable an improved manufacture of wafer rolls to be provided with a substance on the inner side thereof.

The winding device 1 comprises a mandrel 2 which runs along a main axis 5 from a mounted portion 3 to a projecting portion 4. A free end 19 is formed by the projecting configuration of the mandrel 2. In the region of the free end 19 the substance channel 8 emerges from the mandrel 2 with the result that the substance conveyed in the substance channel 8 also emerges and can be introduced into the interior of the wafer roll. The mandrel 2 is delimited in its projection portion 4 by a winding wall 6 at least in sections. The winding wall 6 forms a part of the mandrel 2 in the projecting portion 4. A cylindrical winding surface 7 is provided externally on the winding wall 6, which winding surface is adapted for abutment and winding of the warm wafer strip. Furthermore, the winding device 1 comprises a pressing roller 18, which is arranged rotatably and optionally driven about an auxiliary axis. Furthermore, the winding device 1 comprises connections for supplying a temperature-control medium and at least one connection for supplying the substance.

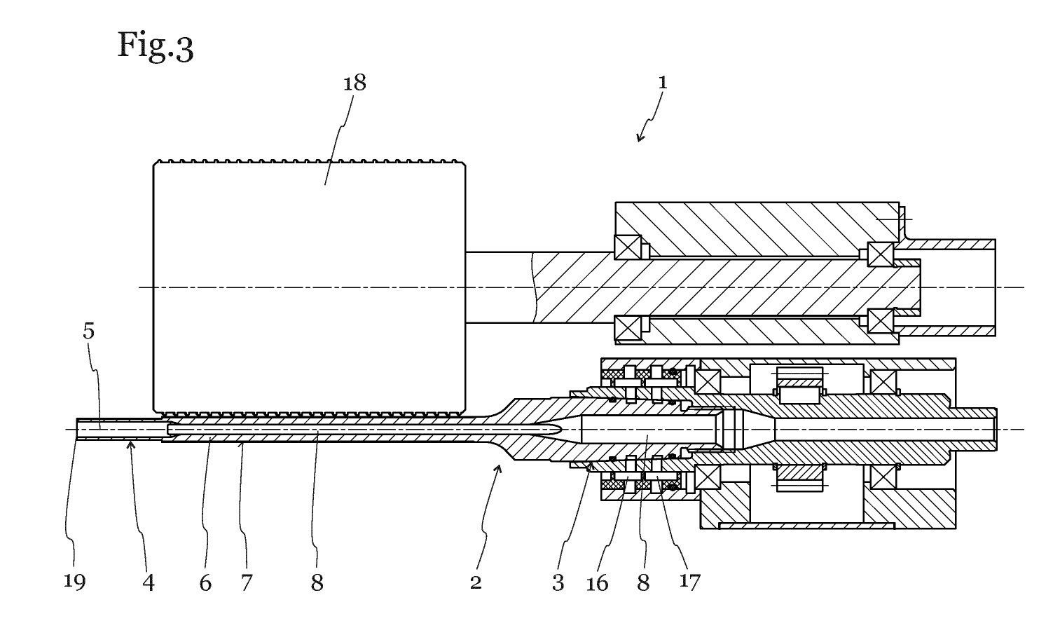

FIG. 3 shows a sectional view of the embodiment of the winding device 1 according to FIG. 2. The winding device 1 comprises a mandrel 2 which again extends from a mounted portion 3 to a projecting portion 4, wherein the projecting portion 4 comprises a free end 19. The mandrel 2 extends in particular along a main axis 5. The mandrel 2 is at least partially delimited by a winding wall 6 which carries a winding surface 7 on its outer side. In particular, the winding surface 7 is the outer side of the winding wall 6. A substance channel 8 is provided in the interior of the winding wall 6 and in particular in the interior of the mandrel 2. This substance channel 8 emerges in the region of the free end 19 of the mandrel 2 in order to be able to introduce the substance into the wafer roll. According to a preferred embodiment, the substance channel 8 extends substantially centrally along the main axis 5 through the mandrel 2 and is preferably fed at its end opposite the projecting section 4, in particular in the mounted portion 3, in the axial direction. Furthermore, a temperature-control channel not visible in this diagram is provided. The temperature-control channel extends, as can be seen in the further figures, through parts of the mandrel 2. The temperature-control channel is fed in the mounted portion 3 through an annular chamber, wherein in particular an annular feed chamber 16 for supplying the temperature-control medium and an annular discharge chamber 17 for discharging the temperature-control medium are provided. These annular chambers 16, 17 are arranged in a substantially fixed position on a base body of the winding device 1 and filled with a temperature-control medium such as, for example, with a cooling medium. In particular, the temperature-control medium is supplied to the annular feed chamber 16 by a pump.

Furthermore, the winding device 1 comprises a pressing roller 18, wherein a winding gap is held free between the pressing roller 18 and the mandrel 2, in which the winding or the conveying of the wafer roll to be formed takes place.

The mandrel 2 is preferably rotatably mounted and driven by means of a drive, rotatably about the main axis 5. The mounting is accomplished for example as in this embodiment by means of two axially spaced-apart bearings, in particular ball bearings. The temperature-control medium can be supplied, for example, through two annular chambers 16, 17 which are spaced apart along the main axis 5.

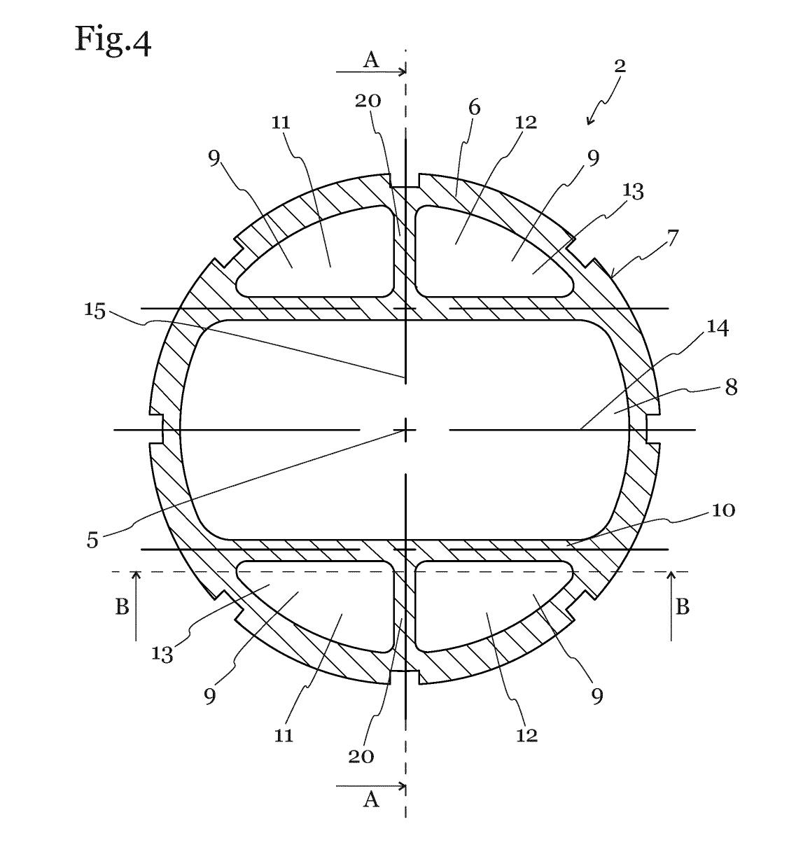

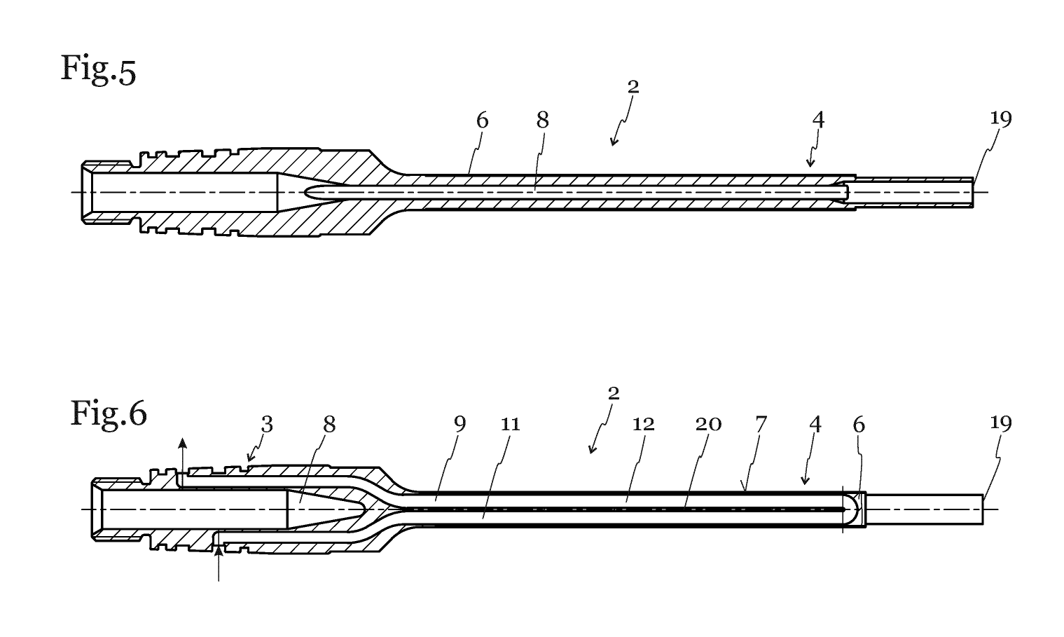

FIG. 4 shows a section through the mandrel 2 of the winding device 1 along a plane of intersection which is arranged in the region of the winding wall 6, wherein the main axis 5 in the diagram of FIG. 4 runs substantially projecting. The mandrel 2 comprises a winding wall 6 with an exterior winding surface 7 which is configured to be substantially cylindrical or has a circular cross-section. The circular cross-section can in all embodiments, as also in this embodiment, be interrupted by indentations or recesses such as grooves. Overall however, a substantially circular or cylindrical shape is obtained. In the interior of the mandrel 2, in particular internally inside the winding wall 6, a substance channel 8 is provided. The substance channel 8 is delimited by a substance channel wall 10. Furthermore, at least one temperature-control channel 9 is provided. In the present embodiment, two temperature-control channels 9 are provided. The temperature-control channels 9 each comprise a first portion 11 and a second portion 12, wherein the first portion 11 for example is for the supply of the temperature-control medium and the second portion 12 is the return portion for example, for the return of the temperature-control medium. The substance channel 8, in particular the substance channel wall 10, has an elongate cross-section. In the present embodiment, the elongate cross-section is configured to be substantially oval (oblong). The substance channel 8 extends along the first cross-section axis 14 from one side of the winding wall 6 to the other side of the winding wall 6. Along the second cross-section axis 15 the substance channel 8 and in particular the substance channel wall 10 is arranged at a distance from the outer regions of the winding wall 6, with the result that at least one, in the present case two free cross-sections 13 are formed. In particular, the temperature-control channels 9 are arranged in these free cross-sections 13. In the present embodiment, the free cross-sections 13 have a substantially chord-defined segment shape and are preferably interrupted centrally by a temperature-control channel wall 20 which in particular separates the first portion 11 of the temperature-control channel 9 from the second portion 12 of the temperature-control 9. The temperature-control channel wall 20 preferably ends just before the complete extension length of the temperature-control channel 9 so that in the projecting region, in particular in the region of the maximum distance of the temperature-control channel 9 from the mounted cross-section, an opening is formed from the first portion 11 to the second portion 12.

FIG. 5 shows a schematic sectional view of mandrel 2 of the winding device 1, which in particular is formed according to the preceding figures, wherein the sectional plane runs substantially along the second cross-section axis 15 depicted in FIG. 4 or the interface A-A. The elongate substance channel 8 extends as far as onto the inner side of the winding wall 6. In the projecting portion 4 of the mandrel 2, in particular in the region of the free end 19 of the mandrel 2, a portion with reduced diameter is provided. This portion is in particular free from temperature-control channels 9.

FIG. 6 shows a further sectional view of a mandrel 2, which in particular is configured according to the preceding figures, wherein the plane of intersection B-B runs substantially parallel to the first cross-section axis 14 of FIG. 4 and in particular just next to the substance channel wall 10. The mandrel 2 comprises a substance channel 8 which emerges from the mandrel 2 in the region of the free end 19. Furthermore, the mandrel 2 comprises a winding wall 6 with an external winding surface 7. Two temperature-control channels 9 are provided inside the winding surface 7. The temperature-control channels 9 each extend from the mounted region 3 of the mandrel 2 into the projecting portion 4 of the mandrel 2 and back again into the mounted portion 3 of the mandrel 2. The temperature-control medium is fed into the temperature-control channel 9 in particular via an annular feed chamber 16 which can be seen, for example, in FIG. 3. The temperature-control medium is discharged in particular via an annular discharge chamber 17 which can also be deduced from FIG. 3 for example. The temperature-control channel 9 extends in the mounted portion 3 of the mandrel 2 substantially radially or obliquely outwards where an opening is also accomplished through the outer wall of the mandrel 3. In particular, the temperature-control channel 9 or this opening opens into the annular feed chamber 16. As a result, the temperature-control medium can be introduced via the annular feed chamber 16 into the first portion 11 of the temperature-control channel 9. From there the temperature-control medium is conveyed in the temperature-control channel 9 or in the temperature-control channels 9 into the projecting portion of the mandrel 2. In the front region, in particular in the front region of the projecting portion 4, the temperature-control medium passes from the first portion 11 of the temperature-control channel 9 into the second portion 12 of the temperature-control channel 9 and is again conveyed back from the projecting portion 4 of the mandrel 2 into the mounted portion 3 of the mandrel 2. In the mounted portion 3 the second portion 12 of the temperature-control channel 9 emerges substantially in the radial direction or obliquely from the mandrel 2, wherein the annular discharge chamber 17 is provided in this region, which enables the temperature-control medium to be discharged.

According to an embodiment not shown, a temperature-control channel 9 extends at least in sections in a spiral or helical manner from the mounted portion 3 of the mandrel 2 into the projecting portion 4 of the mandrel 2 and back again into the mounted portion 3 of the mandrel 2. The temperature-control channel 9 is configured similarly to the other embodiments in a U shape wherein, however its profile is not rectilinear but is configured to be spiral or helical. Optionally a plurality of temperature-control channels 9 can be provided with a spiral configuration.

In the spiral embodiment, it can for example be provided that this substance channel 8 having an elongate cross-section is also configured to be spiral. In particular, such a substance channel 8 can have an elongate cross-section, wherein the elongate cross-section is inclined or rotates along the profile of the main axis 5. Thus, the elongate cross-section has a first cross-section axis 14 and a second cross-section axis 15, wherein the substance channel 8 has a greater extension along its first cross-section axis 14 than along its second cross-section axis 15. Along the course of the main axis 15 these axes are twisted with the result that a spiral configuration of the substance channel 8 along the main axis 5 is obtained. The temperature-control channels 9 are preferably arranged in the spirally configured free cross-sections 13 formed by this rotation along the main axis 5.

According to an alternative configuration, the substance channel 8 is arranged centrally, in particular concentrically to the winding wall 6 or to the winding surface 7. In this embodiment at least one temperature-control channel 9 extends in an annular region between substance channel wall 10 and winding wall 6, wherein preferably two or more temperature-control channels 9 can be provided. These temperature-control channels 9 can run in the region between the substance channel wall 10 and the winding wall 6 rectilinearly or spirally, an in particular in a U shape.

According to a preferred embodiment, the temperature-control channels 9 are arranged spirally and wrap around a centrally arranged substance channel 8. Also in this embodiment, the temperature-control channel 9 or the temperature-control channels 9 are formed in a U shape and extend from the mounted portion 3 into the projecting portion 4 and back again into the mounted portion 3.

1.-17. (canceled)

18. A winding device (1) for the continuous production of edible wafer rolls provided on the inside with an edible substance, comprising:
a mandrel (2) running along a main axis (5), the mandrel (2) having a mounted portion (3), a projecting portion (4) having a free end (19), and a cylindrical winding wall (6), wherein the mandrel (2) in its projecting portion (4) is delimited transversely to the main axis (5) by the cylindrical winding wall (6), the cylindrical winding wall (6) having an exterior winding surface (7) which is adapted for abutment and for rolling of a warm plastically deformable wafer strip and by means of which, during operation, heat transfer takes place due to the abutment of the wafer strip,
the interior of the cylindrical winding wall (6) defining a substance channel (8) running along the main axis (5) and at least one temperature-control channel (9), said substance defining channel adapted for introducing the edible substance into an interior of an endless sleeve-shaped hollow body or wafer roll, wherein the substance channel (8) exits from the mandrel (2) in the region of the free end (19), and wherein the substance channel (8) is delimited by a substance channel wall (10), and wherein said at least one temperature-control channel (9) is adapted for guiding a temperature-control medium provided in the interior of the cylindrical winding wall (6),
wherein the temperature-control channel (9) extends from the mounted portion (3) of the mandrel (2) into the projecting portion (4) of the mandrel (2) and back again into the mounted portion (3) of the mandrel (2).

19. The winding device (1) according to claim 18, wherein the temperature-control channel (9) runs between the substance channel (8) and the winding wall (6).

20. The winding device (1) according to claim 18 wherein the temperature-control channel (9) is substantially U-shaped and extends as a closed line from the mounted portions (3) of the mandrel (2) into the projecting portion (4) of the mandrel (2) and back again into the mounted portion (3) of the mandrel (2).

21. The winding device (1) according to claim 18, wherein the temperature-control channel (9) comprises a first portion (11) which extends in the interior of the winding wall (6) along the main axis (5) from the mounted portion (3) of the mandrel (2) into the projecting portion (4) of the mandrel (2), and a second portion (12) downstream of the first portion (11) which extends in the interior of the winding wall (6) along the main axis (5) from the projecting portion (4) of the mandrel (2) back again into the mounted portion (3) of the mandrel (2).

22. The winding device (1) according to claim 18, wherein the temperature-control channel (9) is at least partially delimited or formed by the substance channel wall (10) and by the winding wall (6).

23. The winding device (1) according to claim 18, wherein the winding wall (6) has a circular or round cross-section, the substance channel (8) in the interior of the winding wall (6) has a round cross-section arranged concentrically to the winding wall (6), and the temperature-control channel (9) is arranged in the free annularly shaped cross-section (13) between the substance channel wall (10) of the substance channel (8) and the winding wall (6).

24. The winding device (1) according to claim 18, wherein the winding wall (6) has a circular or round cross-section, the substance channel (8) in the interior of the winding wall (6) has an elongate cross-section, and the temperature-control channel (9) is arranged in the free cross-section (13) between the substance channel wall (10) of the substance channel (8) and the winding wall (6).

25. The winding device (1) according to claim 18 wherein the winding wall (6) has a round or circular cross-section, the substance channel (8) and/or the substance channel wall (10) has an elongate cross-section in the region of the winding wall (6), wherein the elongate cross-section extends along a first cross-section axis (14) from the one side of the winding wall (6) to the opposite side of the winding wall (6), and wherein a free cross-section (13) in which the temperature-control channel (9) is arranged is provided between the elongate cross-section of the substance channel wall (10) and the winding wall (6) along a second cross-section axis (15) running normally to the first cross-section axis (14) in the cross-section plane.

26. The winding device (1) according to claim 18, wherein the winding wall (6) has a round or circular cross-section, the substance channel (8) and/or the substance channel wall (10) has an elongate cross-section in the region of the winding wall (6), wherein the elongate cross-section extends along a first cross-section axis (14) from the one side of the winding wall (6) to the opposite side of the winding wall (6), and wherein a free cross-section (13) in which the first portion (11) and the second portion (12) of the temperature-control channel (9) are arranged adjacently following the main axis (5) is provided between the elongate cross-section of the substance channel wall (10) and the winding wall (6) along a second cross-section axis (15) running normally to the first cross-section axis (14) in the cross-section plane.

27. The winding device (1) according to claim 18, wherein the temperature-control channel (9) runs at least in sections spirally or helically between the substance channel wall (10) of the substance channel (8) and the winding wall (6).

28. The winding device (1) according to claim 18, wherein at least two temperature-control channels (9) are provided in the interior of the cylindrical winding wall (6) for conducting a temperature-control medium.

29. The winding device (1) according to claim 28, wherein, the substance channel (8) in the interior of the winding wall (6) has an elongate cross-section, and the two temperature-control channels (9) are arranged on both sides of the substance channel (8) in the free cross-sections (13) between the substance channel wall (10) of the substance channel (8) and the winding wall (6).

30. The winding device (1) according to claim 18, wherein the mandrel (2) is arranged rotatably or rotatably driven about the main axis (5), the mandrel (2) is surrounded in the region of its mounted portion (3) by an annular feed chamber (16) for supplying the temperature-control medium into the temperature-control channel (9) of the rotating mandrel (2), and the mandrel (2) in the region of its mounted portion (3) is spaced apart from the annular feed chamber (16) by an annular discharge chamber (17) for discharging the temperature-control medium from the temperature-control channel (9) of the rotating mandrel (2).

31. The winding device (1) according to claim 18, wherein the temperature-control channel (9) comprises a first portion (11) which extends in the interior of the winding wall along the main axis (5) from the mounted portion (3) of the mandrel (2) into the projecting portion (4) of the mandrel (2), the temperature-control channel (9) comprises a second portion (12) downstream of the first portion (11) which extends in the interior of the winding wall along the main axis (5) from the projecting portion (4) of the mandrel (2) back again into the mounted portion (3) of the mandrel (2), the first portion (11) extends as far as into the mounted portion (3) of the mandrel (2) and there opens in the radial direction or obliquely into the annular feed chamber (16), and the second portion (12) extends as far as into the mounted portion (3) of the mandrel (2) and there opens in the radial direction into the annular discharge chamber (17).

32. The winding device (1) according to claim 18, further comprising a pressing roller (18) which is rotatable or driven rotatably about an auxiliary axis.

33. A baking machine (26) for the continuous production of edible wafer rolls comprising:
at least one continuously circulating heated baking surface (21) for baking at least one endless wafer strip (22) which is plastically deformable in the warm state and which is made of a liquid sugar-containing wafer dough;
a processing station (23) in which for each baked wafer strip (22) there is provided a removing device (24) adjacent to the baking surface (21);
a winding device (1) according to claim 18 and located downstream of the removing device (24) for producing an endless sleeve-shaped hollow body; and
a cutting device (25) downstream of the winding device (1) for cutting to length the sleeve-shaped hollow body into individual wafer rolls.

34. A baking machine (26) according to claim 33, characterized in that each winding device (1) has a winding gap arranged obliquely to the path of the relevant baked wafer strip (22) which is formed between two oppositely rotating winding units of which one winding unit is configured as a mandrel (2) around which the baked wafer strip (22) is wound in a helical overlapping manner to form an endless sleeve-shaped hollow body and the other winding unit is configured as a pressing roller (18) which presses the baked wafer strip against the rotating mandrel (2).
